(19) United States
(12) Patent Application Publication
(10) Pub. No.: US 2011/0044513 A1
(43) Pub. Date: Feb. 24, 2011

(54) METHOD FOR N-WISE REGISTRATION AND MOSAICING OF PARTIAL PRINTS

(75) Inventors: Michael McGonagle, Melbourne, FL (US); Mark Rahmes, Melbourne, FL (US); Josef Allen, Melbourne, FL (US); David Lyle, Titusville, FL (US); Anthony Paullin, Melbourne, FL (US)

Correspondence Address: HARRIS CORPORATION;C/O FOX ROTHSCHILD, LLP, 997 Lenox Drive, Building 3, Lawrenceville, NJ, 08543-5231, US

(73) Assignee: Harris Corporation, Melbourne, FL (US)

(21) Appl. No.: 12/543,723

(22) Filed: Aug. 19, 2009

(51) Int. Cl. G06K 9/00

(52) U.S. Cl. 382/124

(57) ABSTRACT

A method and system for synthesizing multiple fingerprint images into a single synthesized fingerprint template. Sets of features are extracted from each of three or more fingerprint images. Pair-wise comparisons identifying correspondences between sets of features are performed between each set of features and every other set of features. Transformations (translation and rotation) for each set of features are simultaneously calculated based on the pair-wise correspondences, and each set of features is transformed accordingly. A synthesized fingerprint template is generated by simultaneously registering the transformed sets of features.

### BACKGROUND OF THE INVENTION

1. Statement of the Technical Field

The invention is directed to biometric systems. In particular, the invention is directed to fingerprint template synthesis and fingerprint mosaicing.

2. Description of the Related Art

Biometric systems are used to identify individuals based on their unique traits. Biometrics are useful in many applications, including security and forensics. Some physical biometric markers include facial features, fingerprints, hand geometry, and iris and retinal scans. A biometric system can authenticate a user or determine the identity of sampled data by querying a database.

There are many advantages to using biometric systems. Most biometric markers are present in most individuals, unique between individuals, permanent throughout the lifespan of an individual, and easily collectable. However, these factors are not guaranteed. For example, surgical alterations may be used to change a biometric feature such that it does not match one previously collected from the same individual. Furthermore, different biometric features can change over time.

Fingerprints are considered a robust form of biometric identification. A fingerprint is an impression of the raised friction ridges on the epidermis. Fingerprints have lasting permanence and are unique to an individual, making them an ideal means for identification. Fingerprints may be collected from naturally deposited imprints on surfaces. Fingerprints are currently the contact biometric of choice and are likely to remain so for the foreseeable future. Fingerprints are less intrusive than certain other biometrics, for example iris and DNA, though more intrusive than facial recognition or voice prints.

The use of fingerprints as a form of biometric identification began with manual methods for collecting fingerprints and evaluating matches. The “ink technique” of pressing and rolling an individual subject's inked finger on a card is still in use today. One way to produce digital images of fingerprints is to then scan these cards. Solid-state fingerprint readers have become common in automated authentication systems. Currently, they are often the only practical solution. Solid-state fingerprint sensors work based on capacitance, thermal, electric field, laser, radio frequency and other principles. Fingerprint sensors typically generate 2-dimensional fingerprint images, although some fingerprint sensors generate 3-dimensional fingerprint images. The term “fingerprint image” as used herein refers to a digital image of a fingerprint.

Even though fingerprints are unique across individuals, they share common features. These key features have been used in fingerprint verification systems for identification purposes. Level 1 features of fingerprints include loops, whorls and arches formed by the ridges. These features describe the overall shape followed by the ridges. Level 2 features of fingerprints, or minutiae, are irregularities or discontinuities in the ridges. These include ridge terminations, bifurcations, and dots. Level 3 features of fingerprints include ridge pores, ridge shape, as well as scarring, warts, creases and other deformations.

Fingerprint enrollment associates fingerprint data with a specific user. Fingerprint recognition can be divided into verification and identification. In fingerprint verification, a fingerprint is used to verify the claimed identity of a user. In fingerprint identification, fingerprint data from an individual is compared to fingerprint data in a database to seek a match. It is common in the art to store only a fingerprint template rather than the full fingerprint image. A fingerprint template consists of key features extracted from the fingerprint, such as key minutiae points.

There are several complications in creating a fingerprint template. When the curved surface of a finger is pressed over a flat surface, uneven pressure will cause elastic skin deformations in the captured fingerprint reading. Other problems include incomplete readings due to poor contact and noise. Furthermore, for latent fingerprints (i.e. those produced unintentionally, such as fingerprints collected at a crime scene), the information available is often of considerably lower quality and information content. Multiple fingerprint images of the same finger may be collected and combined to overcome these issues.

Fingerprint mosaicing is a technique used to reconcile information presented by two or more fingerprint images. Mosaicing can be accomplished at the image level or the feature level. In image-based mosaicing, fingerprint images are reconciled into a single stitched fingerprint image before the extraction of features to synthesize a fingerprint template. In feature-based mosaicing, features are first extracted from each of the fingerprint images. Then, the features are reconciled, resulting in a synthesized fingerprint template combining the features from the separate fingerprint images. Image-based mosaicing is more computationally complex and is more prone to producing artifacts, resulting in false features being included in the final fingerprint template.

The iterative closest point (ICP) algorithm is one method used to mosaic two or more fingerprint images, either at the image level or at the feature level, for the purpose of creating a fingerprint template. For the sake of clarity, the ICP algorithm will be discussed at the feature level, however the algorithm may equally be applied at the image level.

The ICP algorithm first extracts features from each of the fingerprint images, identifying one set of features for each fingerprint image. The ICP algorithm then selects two sets of features and reconciles them by transformation (translating and rotating) and registration (combining), creating an intermediate synthesized template. The ICP algorithm then iteratively reconciles each of the remaining sets of features with the intermediate synthesized template, such that N sets of features require N−1 distinct reconciliations to produce the final synthesized template.

The ICP algorithm exhibits a number of deficiencies. For instance, the ICP algorithm misaligns sets of features. This misalignment is caused by basing transformation calculations on incomplete information. Specifically, as each set of features is reconciled, only information from the intermediate synthesized template and the set of features being reconciled is considered—information from the remaining sets of features is not considered. This failure to consider information from the remaining sets of features causes misalignment, which ultimately causes the final synthesized template to be inaccurate.

For example, consider the reconciliation of five sets of features, where the second set of features is significantly inaccurate, but the remaining sets of features accurately represent the actual fingerprint. The ICP algorithm will transform the first and second sets of features without considering the third, fourth, or fifth sets of features. In doing so, the ICP algorithm will misalign the first set of features, which was initially accurate, in order to achieve a best fit with the inaccurate second set of features, thereby incorporating the error of the second set of features into the intermediate synthesized template. The third set of features will then be transformed based on the intermediate synthesized template, which has incorporated the error of the second set of features. Moreover, reconciliation of the third set of features is performed without consideration of the fourth and fifth sets of features, and so any error compounded by or introduced by reconciliation of the third set of features will be propagated throughout the remaining iterations.

Generating a fingerprint image mosaic (at the “image level”) with the ICP algorithm introduces another source of error: stitching together misaligned fingerprint images. The ICP algorithm generates a fingerprint image mosaic by iteratively stitching together fingerprint images. However, due to inconsistent skin deformations in the fingerprint images, stitching together fingerprint images causes artifacts at the seams. During subsequent iterations these artifacts may cause transformations to be misaligned. Additionally, when extracting a fingerprint template from the final image mosaic, these artifacts may be mistakenly identified as a feature, or they may cause an actual feature to be missed.

For example, consider the reconciliation of five fingerprint images into a fingerprint image mosaic, where all but the second image are accurate. For instance, the second image may be skewed or stretched along the edge that is adjacent to the first image. When the ICP algorithm reconciles the first and second images, the skewed edge of the second image will cause a misalignment along the seam. This misalignment may then impact the alignment of the third fingerprint image, and so on. Once all of the images have been reconciled, the misalignment along the seam of the first and second image may be interpreted as one or more features, thereby introducing an error into the resulting fingerprint template.

### SUMMARY OF THE INVENTION

The invention concerns a method and system for synthesizing multiple fingerprint images into a single synthesized fingerprint template. In one embodiment, sets of features are extracted from each of three or more fingerprint images. Pair-wise comparisons identifying correspondences between sets of features are performed between each set of features and every other set of features. Pair-wise is defined as pertaining to two objects, such as two sets of features, or two fingerprint images. Transformations (translation and rotation) for each set of features are simultaneously calculated based on the pair-wise correspondences, and each set of features is transformed accordingly. A synthesized fingerprint template is generated by simultaneously registering the transformed sets of features.

Additionally or alternatively, the determined transformations for each set of features may be used to generate an optimal fingerprint image mosaic. In one embodiment, each transformation that was calculated for a set of features is applied to the fingerprint image from which the set of features was extracted. Then, the transformed fingerprint images may be stitched together once, and with full knowledge of the final position of every other fingerprint image.

### DESCRIPTION OF THE DRAWINGS

Embodiments will be described with reference to the following drawing figures, in which like numerals represent like items throughout the figures, and in which:

FIG. 1 is a block diagram of a computer system that may be used in embodiments of the invention.

FIG. 2 is flowchart of image-based mosaicing.

FIG. 3 is a flowchart of feature-based mosaicing.

FIG. 4 is a flowchart of a method of fingerprint template synthesis according to embodiments of the invention.

FIGS. 5a, 5b, and 5c are representations of pairs of corresponding features that have been identified across two sets of features.

FIG. 6 is a representation of a generated fingerprint image mosaic based on the corresponding features identified in FIGS. 5a, 5b, and 5c.

FIG. 7 is a flowchart of a method of generating a fingerprint image mosaic according to embodiments of the invention.

### DETAILED DESCRIPTION

The invention will now be described more fully hereinafter with reference to accompanying drawings, in which illustrative embodiments of the invention are shown. This invention, may however, be embodied in many different forms and should not be construed as limited to the embodiments set forth herein. Accordingly, the present invention can take the form of an entirely hardware embodiment, an entirely software embodiment, or a hardware/software embodiment.

The present invention can be realized in one computer system. Alternatively, the present invention can be realized in several interconnected computer systems. Any kind of computer system or other apparatus adapted for carrying out the methods described herein is suited. A typical combination of hardware and software can be a general-purpose computer system. The general-purpose computer system can have a computer program that can control the computer system such that it carries out the methods described herein.

The present invention can take the form of a computer program product on a computer-usable storage medium (for example, a hard disk or a CD-ROM). The computer-usable storage medium can have computer-usable program code embodied in the medium. The term computer program product, as used herein, refers to a device comprised of all the features enabling the implementation of the methods described herein. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

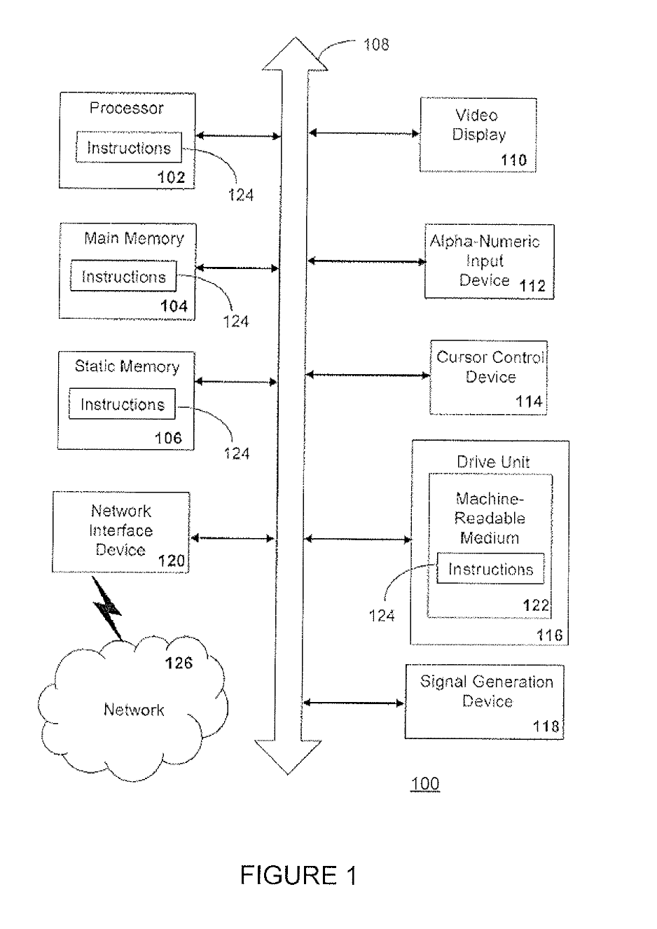

The computer system 100 of FIG. 1 can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 100 includes a processor 102 (such as a central processing unit (CPU), a graphics processing unit (GPU, or both), a main memory 104 and a static memory 106, which communicate with each other via a bus 108. The computer system 100 can further include a display unit 110, such as a video display (e.g., a liquid crystal display or LCD), a flat panel, a solid state display, or a cathode ray tube (CRT)). The computer system 100 can include an input device 112 (e.g., a keyboard), a cursor control device 114 (e.g., a mouse), a disk drive unit 116, a signal generation device 118 (e.g., a speaker or remote control) and a network interface device 120.

The disk drive unit 116 includes a computer-readable storage medium 122 on which is stored one or more sets of instructions 124 (e.g., software code) configured to implement one or more of the methodologies, procedures, or functions described herein. The instructions 124 can also reside, completely or at least partially, within the main memory 104, the static memory 106, and/or within the processor 102 during execution thereof by the computer system 100. The main memory 104 and the processor 102 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present invention, the methods described below are stored as software programs in a computer-readable storage medium and are configured for running on a computer processor. Furthermore, software implementations can include, but are not limited to, distributed processing, component/object distributed processing, parallel processing, virtual machine processing, which can also be constructed to implement the methods described herein.

In the various embodiments of the present invention a network interface device 120 connected to a network environment 126 communicates over the network 126 using the instructions 124. The instructions 124 can further be transmitted or received over a network 126 via the network interface device 120.

While the computer-readable storage medium 122 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Those skilled in the art will appreciate that the computer system architecture illustrated in FIG. 1 is one possible example of a computer system. However, the invention is not limited in this regard and any other suitable computer system architecture can also be used without limitation.

Embodiments of the invention relate to methods for fingerprint template synthesis. The term “fingerprint template synthesis” as used herein refers to any process for creating a fingerprint template. Fingerprint template synthesis includes extracting data comprising features from at least one fingerprint image. Fingerprint template synthesis may include the combination of features extracted from multiple fingerprint images. The term “fingerprint template” as used herein refers to fingerprint data comprising a set of features associated with a fingerprint from one finger. In one embodiment of the invention, the features comprise minutiae points. Other types of features include pores and ridges. The fingerprint data in a fingerprint template can be associated with one individual possessing the finger, and is therefore usable to identify that individual. The set of features comprising a fingerprint template may be extracted from one fingerprint image. The set of features may also be extracted from multiple fingerprint images associated with the finger. A fingerprint template may comprise features extracted from partial fingerprint images.

Image-Based and Feature-Based Mosaicing

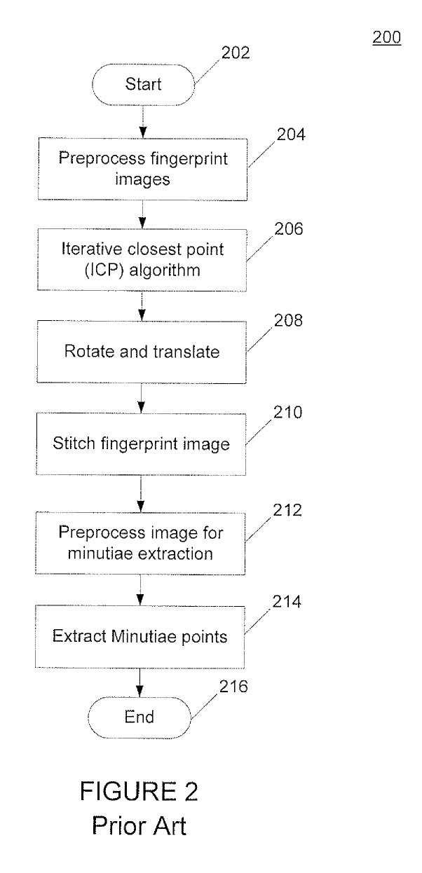

Image-based and feature-based mosaicing have been used in the prior art for fingerprint template synthesis. FIG. 2 is a flowchart that outlines the image-based mosaicing process described in A. Jain, A. Ross, “Fingerprint mosaicking,” IEEE International Conference on Acoustics, Speech, and Signal Processing, 2002, vol. 4, pp. 4064-67 (2002).

Process 200 in FIG. 2 begins 202 and continues with preprocessing of two fingerprint images to extract features 204. The term “preprocessing” as used herein refers to any sequence of mathematical or statistical calculations or transformations applied to an image. Preprocessing may be used in embodiments of the invention to facilitate the extraction of features such as loops, whorls, and arches formed by ridges, as well as minutiae points, pores, scarring, warts, creases, and the like from a fingerprint image. Preprocessing may refer to any combination of preprocessing steps. Preprocessing to facilitate feature extraction may include binarizing the fingerprint and/or thinning the ridges. In one embodiment of the invention, the fingerprint image is a grayscale fingerprint image and preprocessing the fingerprint image comprises binarizing the image, converting it into a black-and-white image. In one embodiment of the invention, preprocessing enhances the ridge lines to facilitate feature extraction.

Subsequent to the preprocessing, the iterative closest point (ICP) algorithm is used to register the two fingerprint images 206. One image is rotated and translated according to the results of the ICP algorithm 208. Then, the two images are stitched into one fingerprint image 210. Subsequent to the stitching, the combined fingerprint image is preprocessed to facilitate feature extraction, such as minutiae extraction 212. Typically, to preprocess a fingerprint image, the image is binarized and the fingerprint ridges are thinned. Various algorithms are known in the art for preprocessing a fingerprint image before feature extraction, such as the SIFT (Scale Invariant Feature Transform) or the SURF (Speeded Up Robust Features) algorithms. Minutiae points are then extracted 214, after which the process terminates 216.

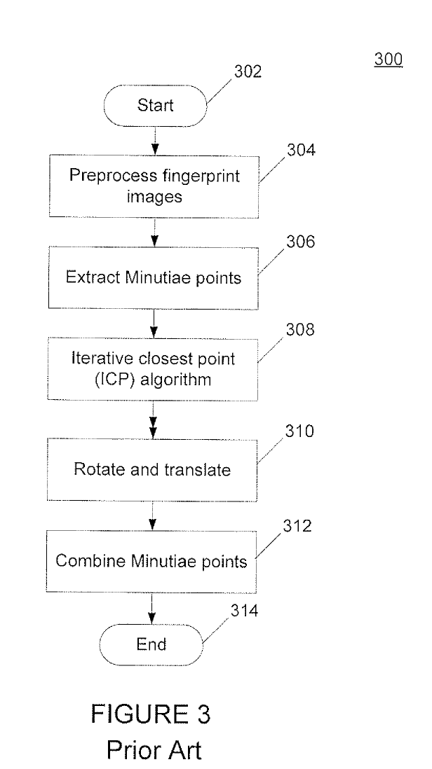

FIG. 3 is a flowchart that outlines the feature-based mosaicing process described in Y. S. Moon, et al., “Template synthesis and image mosaicing for fingerprint registration: an experimental study,” IEEE Conference on Acoustics, Speech, and Signal Processing, 2004, vol. 5, pp. 409-12, (2004).

Process 300 in FIG. 3 begins 302 and continues with preprocessing of two fingerprint images for minutiae extraction 304. Subsequent to the preprocessing, minutiae points are extracted from each fingerprint image 306. Then, the ICP algorithm is used to register the two sets of minutiae points 308. Subsequent to the registration, one set of minutiae points is rotated and translated according to the results of the ICP algorithm 310. The minutiae points are then combined to form a fingerprint template 312, after which the process terminates 314.

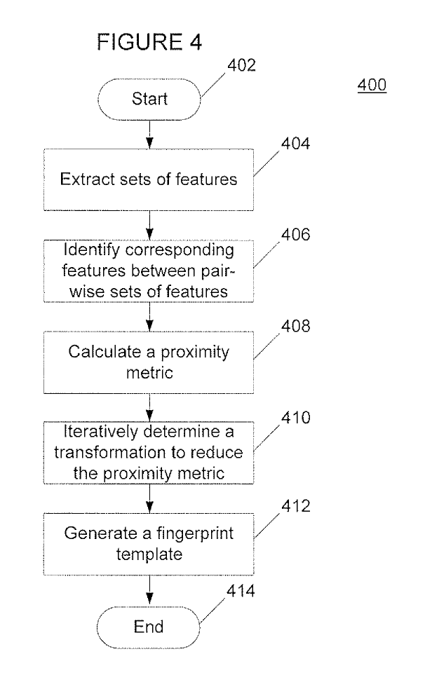

FIG. 4 is a flowchart useful for understanding synthesizing fingerprint templates according to embodiments of the invention. Process 400 in FIG. 4 begins 402 and continues with preprocessing at least one fingerprint image to facilitate feature extraction 404. In one embodiment of the invention, two or more fingerprint images are preprocessed to facilitate feature extraction. A fingerprint image may come from various sources, such as a solid-state fingerprint reader, a digital scan of a manually collected fingerprint, such as a scan of a fingerprint collected from using the ink method, or a latent fingerprint. A fingerprint image may include a partial fingerprint image.

Once the images have been pre-processed, actual feature points may be extracted. One common type of feature is a minutiae point. The term “minutiae point” as used herein refers to any point representation of the location of a minutia. For example, a minutiae point may be a point representation of the location of a minutiae with reference to a fingerprint image. In one embodiment, the point representation is a pixel location in a 2-dimensional fingerprint image. In another embodiment, the point representation is a 3-dimensional point with reference to a 3-dimensional fingerprint image. There are two fundamental types of minutiae: ridge endings and bifurcations. A ridge ending is the point at which a ridge terminates. A bifurcation is the point at which a single ridge splits into two ridges. Other features may be counted as minutiae points. These include what are considered compound minutiae: short ridges (aka islands and dots), lakes (aka enclosure), opposed bifurcations, bridges, double bifurcations, hooks (aka spurs) and bifurcations opposed with an ending. Henry C. Lee et al. Advances in Fingerprint Technology, 374, CRC Press (2d ed. 2001). In one embodiment of the invention, the fundamental types of minutiae points are extracted. In another embodiment of the invention, other selected types of minutiae points are also extracted. In another embodiment, other types of features are extracted, such as the level 1 and level 3 features discussed above. The sets of features may be determined by a computational or statistical evaluation of a preprocessed fingerprint image. In one embodiment of the invention, computational or statistical methods are used to refine the set of features by selecting key features to include in the set of features associated with a fingerprint image.

Returning to feature extraction 404, a set of features is extracted from each fingerprint image. In one embodiment of the invention, each set of features is associated with one fingerprint image. In one embodiment of the invention, a first set of features is extracted from a first fingerprint image and a second set of features is extracted from a second fingerprint image.

Next, correspondences between pairs of images are identified 406. For example, consider a first image and a second image, both representing views of the same actual fingerprint. Each correspondence occurs between one feature in the first image and one feature in the second image. A correspondence exists if the feature of the first image and the feature of the second image both map to the same underlying feature of the actual fingerprint. Multiple correspondences between the first and second images may be identified, each correspondence being associated with one feature in the first image and one feature in the second image. By identifying multiple correspondences, a transformation (translation and/or rotation) aligning the images may be calculated. For instance, if one correspondence is identified between a pair of images, a translation may be performed such that the corresponding features of both images are positioned at the same location. If two correspondences are identified between a pair of images, a transformation (translation and a rotation) aligning the two images may be identified, although more than one such transformation may be possible. If three or more correspondences are identified between a pair of images, a unique transformation may be identified. In one embodiment, calculating the transformation includes determining the transformation that minimizes the sum of the distances between each pair of corresponding features.

Feature correspondences are typically identified between two sets of features, each correspondence having one feature from each of the two sets. However, correspondences between groups containing three or more sets of features are similarly contemplated. A group of two sets of features is therefore known as a pair-wise group of sets of features. In one embodiment, every possible pair-wise grouping of sets of features is analyzed to identify correspondences. In this way, each set of features (and therefore the image from which these features were extracted) is in turn paired with every other set of features, and correspondences identified. One embodiment of the invention calculates a transformation of each set of features based on the corresponding features identified with every other set of features. In one embodiment these transformations minimize the global registration error.

Since correspondences are identified between each set of features and every other set of features, the maximum number of possible pair-wise groups, given an input of N fingerprint images, will be “N choose 2” or N*(N−1)/2. In comparison, prior art methods such as the ICP algorithm perform at most N−1 comparisons.

However, not all pair-wise groups of sets of features will identify a feature correspondence. As fingerprint images may be partial, it is possible for some images to not overlap at all, leaving no corresponding features between the sets of features. In this case, the invention attempts to identify correspondences between the “N choose 2” combinations of sets of features, but may identify correspondences between some smaller number pair-wise groups. Regardless, the invention typically considers information from as many other sets of features as possible in determining a transformation.

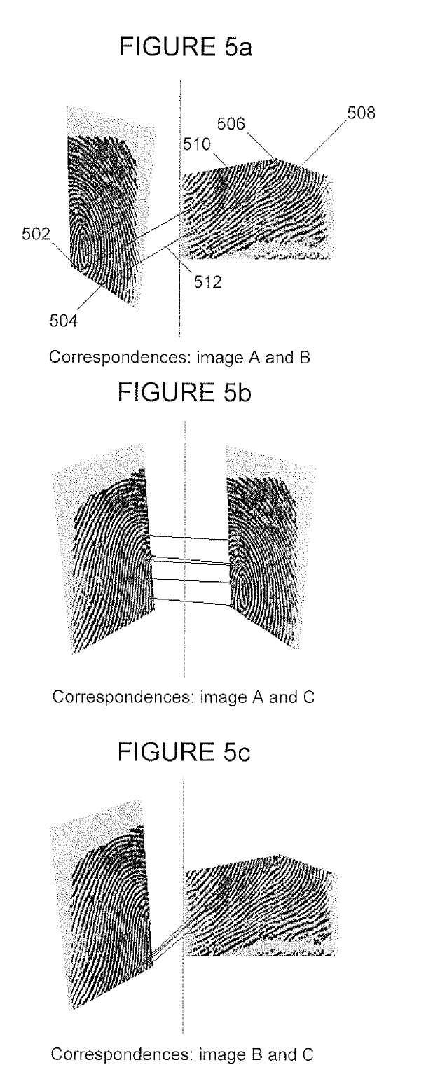

FIGS. 5a, 5b, and 5c illustrate three examples of feature correspondence between pairs of sets of features. For example, FIG. 5a illustrates corresponding features between images A and B. In this instance, images A and B form a pair-wise group. Features 502, 504, 506, and 508 have been extracted from images A and B. Features 502 and 504, extracted from image A, comprise one set of features, while features 506 and 508, extracted from image B, comprise another set of features. Taken together these sets comprise a pair-wise group of sets of features. Two correspondences have been identified between the pair-wise group of sets of features, each being identified by a line extending between the two features. Correspondence 510 associates feature 502 from image A and feature 506 from image B, while correspondence 512 associates feature 504 from image A and 508 from image B. Similarly, FIG. 5b illustrates corresponding features between images A and C. In this case, a set of features extracted from image A and a set of features extracted from image C comprise a pair-wise group of sets of features. As discussed above, correspondences between the features are indicated by lines. In this example, the five features identified in image A are each mapped to five features identified in image C, forming five correspondences. In one embodiment, information extracted from FIGS. 5a and 5b is sufficient to calculate transformations for each image in order to generate a synthesized feature template, or a fingerprint image mosaic. However, these transformations could be improved. For example, when only considering information in FIGS. 5a and 5b, image A and image C are related transitively through image B, not directly to each other. Also, images A and B only have two feature correspondences, potentially creating ambiguity as to the proper transformation. By adding the feature correspondences between images B and C, as depicted in FIG. 5c, accuracy may improve due to the additional correspondences, including a direct relationship between images B and C. In one embodiment, correspondences between features are determined by application of a RANSAC (RANdom Sample Consensus) algorithm.

Subsequent to identifying corresponding features between pair-wise sets of features, a proximity metric is calculated for each identified corresponding pair of features 408. Recall that each corresponding pair of features is comprised of one feature selected from a first feature set and a corresponding feature selected from a second feature set. Typically the proximity metric measures the sum of the distances between each corresponding pair of features. In step 410, as discussed below, the proximity metric is iteratively calculated in order to align the corresponding features from each feature set as close together as possible, thereby approximating the underlying fingerprint on which the source images are based. As depicted in FIGS. 5a, 5b, and 5c, the distance between each corresponding features is depicted by the distance of the line connecting the features. A perfect alignment of all sets of features would have, in one embodiment, a proximity metric of zero. In one embodiment the proximity metric is a linear sum of distances between each identified corresponding feature. In another embodiment, the metric may comprise summing the square of the distances between the identified corresponding features. Other metrics are similarly contemplated.

After the proximity metric has been initially calculated, the N-Wise Registration algorithm iteratively applies transformations to the sets of features such that the proximity metric of the newly transformed sets of features is reduced 410. In one embodiment this iteration is performed without registering or otherwise combining the sets of features or the images underlying the sets of features. For each iteration, one or more sets of features are transformed based on data extracted from the previous proximity metric calculation. Then, the proximity metric is re-calculated using the recently transformed sets of features, and the proximity metric is compared against a threshold to determine when to stop iterating. In one embodiment, step 410 stops iterating when the proximity metric converges within a user-defined limit, based on delta between the current metric and the previous metric. This user-defined threshold may be an absolute difference or a percentage difference. Additionally or alternatively, iterating stops when the proximity metric drops below a user-defined absolute threshold.

Next, a fingerprint template is generated 412. In one embodiment, the fingerprint template comprises the result of the final iteration performed in step 410. Once the fingerprint template has been generated, the process terminates 414.

One or ordinary skill in the art will appreciate that the method described in relation to FIG. 4 considers information available from as many images as possible in determining the ultimate transformation of each set of features. In one embodiment, this consideration is the result of globally minimizing the proximity metric. Specifically, for each feature in a particular image, the distances between that feature and corresponding features in all other images are summed. Prior art methods, such as the ICP algorithm, do not consider all of these correspondences, and instead only consider the distance between each feature being added to the intermediate template and the features already added to the intermediate template. The ICP algorithm ignores features in all other images. By not considering features from these other images, the ICP algorithm operates with less than complete information, resulting in transformations that do not align images or feature sets with each other as accurately as is achieved by the present invention.

Increased accuracy means a greater fidelity with or congruence to the actual fingerprint from which the fingerprint images were captured. Consider the example discussed above in which five fingerprint images are reconciled into a synthesized template, the second fingerprint image being inaccurate. Using the prior art technique, error introduced by the second fingerprint image is compounded throughout the remaining iterations. In contrast, simultaneously calculating transformations of each fingerprint image eliminates this compounding of error. In addition, simultaneously calculating transformations ensures that outliers, such as the second fingerprint image, are identified and given diminished weight. As was exhibited in the example, prior art techniques could not reliably identify outlying sets of features because prior art techniques calculate transformations based on incomplete information.

Another advantage of simultaneously transforming and registering features, in comparison to the prior art technique of iterative pair-wise reconciliation, is consistency of results. The ICP algorithm may provide inconsistent results for a given set of fingerprint images, where the results vary depending on the order in which the images are reconciled. Continuing the example of five fingerprint images with the second fingerprint image being inaccurate, processing the “second” image last would produce a different synthesized fingerprint template than would processing it in the original order, in part because the error introduced by the “second” image would not be propagated and compounded through each iteration. In contrast, in one embodiment of the invention, the order in which fingerprint images are presented and/or processed does not typically affect the result, as the alignment of each fingerprint image considers information from all of the other fingerprint images regardless of the order in which they are processed.

At the “image level”, generating a fingerprint image mosaic by simultaneously transforming and registering images also provides advantages in comparison to the prior art technique of iterative pair-wise image reconciliation. One advantage is the ability reconcile partially overlapping images. Prior art techniques were limited to iteratively stitching together fingerprint images, typically at the seams. In contrast, simultaneously calculating transformations for sets of features extracted from each fingerprint image, and applying the transformations to the corresponding fingerprint images, enables a fingerprint image mosaic to be stitched together in one step with full knowledge of the positions of every fingerprint image. By having full knowledge of the position of every fingerprint image, overlap between fingerprint images can be accounted for, and duplicate or unnecessary stitching can be avoided.

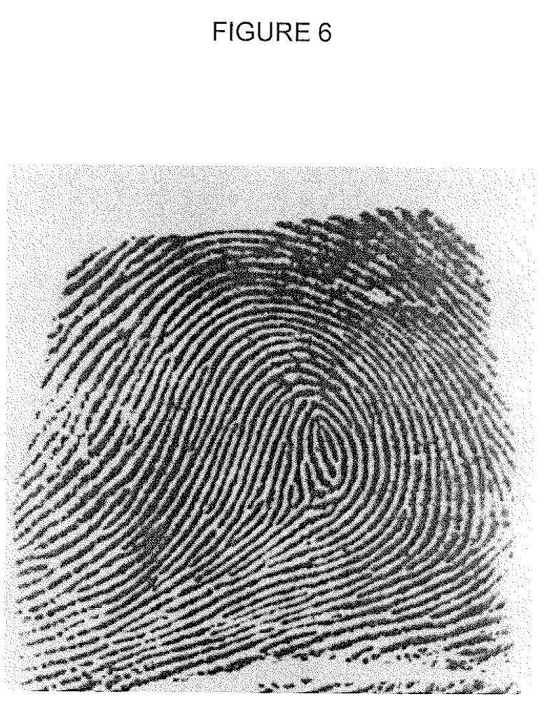

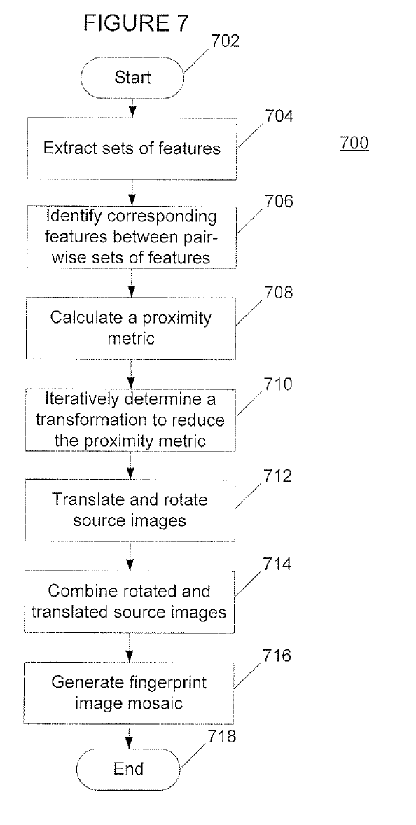

Embodiments of the invention also relate to generating a fingerprint image mosaic. FIG. 7 is a flowchart useful for understanding generation of a fingerprint image mosaic by transforming images based on transformations identified according to embodiments of the invention. Process 700 in FIG. 7 begins 702 and continues with extracting sets of features 704, identifying corresponding features between pair-wise sets of features 706, calculating a proximity metric 708, and iteratively determining a transformation to reduce the proximity metric 710. This portion of the process is analogous to 404 through 410, as discussed with respect to FIG. 4 above. However, instead of generating a fingerprint template, Process 700 translates and rotates fingerprint images 712. In one embodiment, each fingerprint image is translated and rotated according to the translation and rotation calculated for the associated set of features. Subsequent to the images being translated and rotated, the transformed fingerprint images are combined at the edges, or “stitched” together 714. In one embodiment, a Poisson merge or other algorithm may be performed on the resulting combined image to smooth artifacts and misaligned seams. A Poisson merge is a non-linear mathematical equation that makes it less likely to see where the fingerprints were stitched together, adding elasticity to the combination of fingerprint images. After the transformed images have been combined, the fingerprint image mosaic is generated 716. FIG. 6 illustrates a fingerprint image mosaic resulting from the combination of three fingerprint images (images A, B, and C of FIGS. 5a, 5b, and 5c). Optionally, a fingerprint template may be extracted from the generated fingerprint image mosaic. Once the fingerprint image mosaic is generated, the process terminates 718.

All of the apparatus, methods and algorithms disclosed and claimed herein can be made and executed without undue experimentation in light of the present disclosure. While the invention has been described in terms of preferred embodiments, it will be apparent to those of ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to one of ordinary skill in the art are deemed to be within the spirit, scope and concept of the invention as defined.

What is claimed is:

1. A method implemented on a computing device for fingerprint template synthesis, the method comprising:
extracting a set of features from each of at least three fingerprint images;
for at least one pair-wise group of the extracted sets of features, identifying at least one pair of corresponding features;
iteratively determining a transformation for each of the extracted sets of features, wherein a transformation of each extracted set of features is based on every other set of extracted features.

2. The method according to claim 1, wherein features are selected from the group consisting of a pore, a crease, and a minutiae point.

3. The method according to claim 1, wherein features are extracted with an image feature extraction algorithm, such as SIFT or SURF, to obtain feature descriptors.

4. The method according to claim 1 further comprising generating a fingerprint image mosaic by:
transforming each of the at least three fingerprint images according to the transformation determined for the extracted set of features corresponding to the fingerprint image; and
combining the transformed fingerprint images into the fingerprint image mosaic.

5. The method according to claim 4, wherein combining includes applying an image smoothing algorithm along the seams of the fingerprint image mosaic.

6. The method according to claim 5, wherein the image smoothing algorithm comprises a Poisson merge.

7. The method according to claim 4, wherein at least two of the transformed fingerprint images overlap each other.

8. The method according to claim 1, wherein the iteration stops when the proximity metric crosses a user-defined threshold.

9. The method according to claim 1 further comprising calculating a proximity metric based on a proximity of each identified pair of corresponding features, wherein each iteratively determined transformation reduces the proximity metric in comparison to the previous iteration.

10. A system for generating a fingerprint image mosaic comprising:
a computing device for:
extracting a set of features from at least three fingerprint images,
for at least one pair-wise group of the extracted sets of features identifying at least one pair of corresponding features,
iteratively determining a transformation for each of the extracted sets of features, the transformation of each extracted set of features being based on every other set of extracted features,
transforming each of the at least three fingerprint images according to the transformation determined for the extracted set of features corresponding to the fingerprint image, and
combining the transformed fingerprint images into the fingerprint image mosaic; and
a computer-readable storage medium for storing the combined transformed fingerprint images determined by the computing device.

11. The system of claim 10, wherein features are selected from the group comprising a loop, a whorl, and an arch.

12. The system of claim 10, wherein features are extracted with a an image feature extraction algorithm, such as SIFT or SURF, to obtain feature descriptors.

13. The system of claim 10, the computing device further:
calculating a proximity metric based on a proximity of each identified pair of corresponding features, wherein each iteratively determined transformation reduces the proximity metric in comparison to the previous iteration.

14. The system of claim 10, the computing device further applying a Poisson merge to the fingerprint image mosaic.

15. A server computer system for generating a fingerprint template comprising:
a processor;
a memory in communication with the processor and storing instructions that when executed by the processor perform actions comprising:
extracting a set of features from each of at least three fingerprint images;
for at least one pair-wise group of the extracted sets of features, identifying at least one pair of corresponding features;
calculating a proximity metric based on a proximity of each identified pair of corresponding features;
iteratively determining a transformation for each of the extracted sets of features that reduces the proximity metric, wherein a transformation of each extracted set of features is based on every other set of extracted features.

16. The server computer system of claim 15, wherein the proximity metric is calculated by summing the distances between each identified pair of corresponding features.

17. The server computer system of claim 15, wherein the iteratively determining terminates when the proximity metric converges within a user-defined threshold.

18. The server computer system of claim 15, wherein the memory further includes instructions that when executed by the processor perform actions comprising:
transforming each of the at least three fingerprint images according to the transformation determined for the extracted set of features corresponding to the fingerprint image; and
combining the transformed fingerprint images into the fingerprint image mosaic.

19. The server computer system of claim 18, wherein the memory further includes instructions that when executed by the processor perform actions comprising applying Poisson merge algorithm to the fingerprint image mosaic.

20. The server computer system of claim 15 further comprising calculating a proximity metric based on a proximity of each identified pair of corresponding features, wherein each iteratively determined transformation reduces the proximity metric in comparison to the previous iteration.
